(19) United States
(12) Patent Application Publication
(10) Pub. No.: US 2006/0175772 A1
(43) Pub. Date: Aug. 10, 2006

(54) Substrate holding mechanism using electrostaic chuck and method of manufacturing the same

(75) Inventor: Toshihisa Nozawa, Hyogo (JP)

Correspondence Address: CROWELL & MORING LLP;INTELLECTUAL PROPERTY GROUP, P.O. BOX 14300, WASHINGTON, DC, 20044-4300, US

(73) Assignee: TOKYO ELECTRON LIMITED, Minato-ku (JP)

(21) Appl. No.: 10/549,177

(22) PCT Filed: Mar. 17, 2004
(86) PCT No.: PCT/JP04/03541

§ 371 Date: Sep. 16, 2005

(30) Foreign Application Priority Data
Mar. 19, 2003 (JP) 2003075171

(51) Int. Cl. B32B 38/00

(52) U.S. Cl. 279/128; 156/280

(57) ABSTRACT

A substrate holding apparatus includes a stage configured to support a substrate to be processed, the stage including a surface, and a continuous convex portion surrounding a predetermined region of the surface which convex portion includes a periphery surface and an upper surface that is positioned higher than the surface of the stage; an electrostatic attraction sheet configured to attract a substrate with electrostatic force, the electrostatic attraction sheet being arranged on the surface of the stage within the region surrounded by the convex portion; a first protection member configured to protect the electrostatic attraction sheet, the first protection member being arranged on the electrostatic attraction sheet and including a side surface and a portion that is arranged to face opposite the upper surface of the convex portion; an adhesive layer that is arranged at least between the electrostatic attraction sheet and the first protection member and is configured to bond the electrostatic attraction sheet and the first protection member; and a second protection member that covers at least the outer peripheral surface of the convex portion and the side surface of the first protection member to conceal at least the adhesive layer.

### TECHNICAL FIELD

The present invention generally relates to a substrate processing apparatus that performs processes such as a CVD process and/or an etching process on a semiconductor substrate and a method of manufacturing the same. The present invention particularly relates to a substrate holding apparatus implementing an electrostatic fastener that is used for holding a substrate within such a substrate processing apparatus and a method of manufacturing the same.

### BACKGROUND ART

Processes for manufacturing a semiconductor device include numerous steps. For example, a process for forming a circuit pattern on a semiconductor wafer (referred to as wafer hereinafter) may include a cleaning step for cleaning the wafer, a film formation step for forming metal films and/or insulating films, a photolithography step for forming a wiring pattern using a photo resist, an etching step for etching the wafer with the resist pattern formed thereon, and other various steps such as a step for implanting impurities.

In the case of using plasma in the etching step described above, or in the case of using a CVD apparatus in the film formation step, for example, the wafer is introduced into a vacuum chamber and processing is performed within such a vacuum chamber.

In a CVD apparatus or an etching apparatus, an electrostatic fastener is used for holding a substrate to be processed within a chamber.

A conventionally used electrostatic fastener includes an electrostatic attracting (electrostatic force of attraction) sheet that is placed between a fastener main body and a wafer. The fastener main body is made of a conductor so that a high frequency voltage may be applied thereto. The electrostatic attraction sheet corresponds to a flexible sheet and may include two polyimide sheets as insulating layers, for example, and a conductive sheet such as a copper sheet arranged between the insulating layers (e.g., see Japanese Laid-Open Patent Publication No. 5-200640).

Also, an electrostatic fastener that includes a ceramic film for protecting the electrostatic attraction sheet that is formed on the electrostatic attraction sheet through spraying, for example, is known. However, in such a structure, a wafer is attracted and held by the ceramic film during substrate processing, and thereby, the ceramic material may come off and be attached to the wafer. In response to such a problem, recently and continuing, a structure is being used that is realized by bonding a sintered ceramic sheet on the electrostatic attraction sheet using adhesive as opposed to forming the ceramic film through spraying.

However, in a CVD apparatus or an etching apparatus according to the prior art including such a ceramic sheet that is bonded to the electrostatic attraction sheet using adhesive, when oxygen plasma or fluorine plasma is used, for example, corrosion of the adhesive layer may be induced by the plasma. When such corrosion occurs, the electrostatic attraction sheet made of polyimide and/or the ceramic sheet may come off so that particles may be generated. Also, the service life of the electrostatic fastener may be shortened due to such corrosion of the adhesive layer.

### DISCLOSURE OF THE INVENTION

Accordingly, it is a general object of the present invention to provide a novel and effective substrate holding apparatus that solves one or more of the problems of the related art, a method for manufacturing the same, and a substrate processing apparatus that includes such a substrate holding apparatus.

A more specific object of the present invention is to provide a substrate holding apparatus including a mechanism including a ceramic sheet that is attached to an electrostatic attraction sheet via an adhesive layer, in which corrosion of the adhesive layer may be prevented, the service life of the mechanism may be enhanced, and particle generation may be reduced. It is also an object of the present invention to provide a method for manufacturing such a substrate holding apparatus, and a substrate processing apparatus that includes such a substrate holding apparatus.

It is another object of the present invention to provide a substrate processing apparatus including:

a stage configured to support a substrate to be processed, the stage including a surface, and a continuous convex portion surrounding a predetermined region of the surface which convex portion includes a periphery surface and an upper surface that is positioned higher than the surface of the stage;

an electrostatic attraction sheet configured to attract a substrate with electrostatic force, the electrostatic attraction sheet being arranged on the surface of the stage within the region surrounded by the convex portion;

a first protection member configured to protect the electrostatic attraction sheet, the first protection member being arranged on the electrostatic attraction sheet and including a side surface and a portion that is arranged to face opposite the upper surface of the convex portion;

an adhesive layer that is arranged at least between the electrostatic attraction sheet and the first protection member and is configured to bond the electrostatic attraction sheet and the first protection member; and

a second protection member that covers at least the outer peripheral surface of the convex portion and the side surface of the first protection member to conceal at least the adhesive layer.

According to the present invention, a attraction sheet is placed on a region that is surrounded by a convex portion formed on the surface of a stage, and a first protection member is bonded to this attraction sheet via an adhesive layer. Also, a second protection member is arranged to cover the periphery surface of the convex portion and the side surface of the first protection member. In this way, the adhesive layer may be protected from exposure to plasma and corrosive atmosphere so that corrosion of the adhesive layer may be prevented. In turn, particle generation may be prevented and the service life of the substrate processing apparatus may be prolonged. It is particularly noted that by providing the convex portion, the adhesive layer may be protected, and by covering the periphery surface of the convex portion and the side surface of the first protection member with the second protection member, protection of the adhesive layer may be further ensured. It is noted that in the present invention, the second protection member does not necessarily have to cover the entire periphery surface and the entire side surface. Rather, the present invention may be adequately realized by covering and concealing with the second protection member at least the portion at which the first protection member and the convex portion are facing opposite each other.

According to one embodiment of the present invention, the second protection member corresponds to a film formed through spraying. By using a spraying process, the second protection member may be easily formed. In a case of forming the second protection member through spraying at portions where the adhesive layer is exposed, carbonization of the adhesive layer may possibly occur due to heat of the spraying process. However, according to the present invention, since the convex portion is provided, even when the second protection member is formed on the periphery surface of the convex portion through spraying, problems such as carbonization of the adhesive layer may be avoided.

According to another embodiment of the present invention, a thermal expansion rate of the stage and a thermal expansion rate of the first protection member are arranged to be substantially the same. In a case where the thermal expansion rates of the stage and the first protection member are not the same, either one of the stage or the first protection member may expand at a greater rate than the other when the second protection member is formed through spraying, and the protection member may possibly break as a result. By arranging the thermal expansion rates of the stage and the first protection member to be substantially the same, such a problem may be avoided. It is noted that the first protection member is preferably made of ceramic, and the stage is preferably made of aluminum, titanium, molybdenum, or tungsten that includes ceramic.

According to another embodiment of the present invention, a gap is created between the first protection member and the convex portion, and this gap is arranged to have a dimension of 10˜30 μm. Also, the upper surface of the convex portion has a width of 50˜150 μm. Specifically, when the dimension of the gap is 10˜30 μm, the width of the upper surface of the convex portion is preferably arranged to be 50˜150 μm so that the aspect ratio of the convex portion may be at least 5. By arranging the aspect ratio to be at least 5 when the gap has a dimension of 10˜30 μm, material that is sprayed upon forming the second protection member through spraying may be prevented from reaching the adhesive layer arranged at the inner side of the convex portion.

According to an embodiment of the present invention, a first through hole that penetrates through the first protection member, the electrostatic attraction sheet, and the stage are formed; and a pin configured to transfer the substrate is arranged in the first through hole to be raised and lowered relative to the first through hole. Further, a third protection member that is arranged to conceal the adhesive layer is arranged in the first through hole. Conventionally, the stage has a first through hole that penetrates through the first protection member, a pin for transferring the substrate being inserted through this first through hole. According to the present invention, a third protection member is arranged to cover at least a portion within the first through hole where the adhesive layer is exposed in order to prevent exposure of the adhesive layer. In this way, even when plasma penetrates into the first through hole, the adhesive layer may be protected. It is noted that the term ‘relative to’ is used in the present context to imply that the pin may be raised/lowered, or the stage may be raised/lowered.

According to another embodiment of the present invention, a film formed through spraying is used as the third protection member. It is noted that the third protection member may be easily formed through spraying.

According to another embodiment of the present invention, the first protection member and the electrostatic attraction sheet respectively include a first hole and a second hole that make up the first through hole, the second hole being arranged to be larger in dimension compared to the first hole. In this way, when forming the third protection member, carbonization of the adhesive layer caused by penetration of spayed material through the gap formed between an attracting member including the electrostatic attraction sheet and the first protection member may be prevented, for example.

According to another embodiment of the present invention, a second through hole that penetrates through the first protection member, the electrostatic attraction sheet, and the stage is formed; and a gas supply unit configured to supply heat transfer gas to the substrate at least via the second through hole and a fourth protection member that is arranged in the second through hole and is arranged to conceal the adhesive layer are provided. Conventionally, the stage has a second through hole that penetrates through the first protection member, gas for realizing heat transfer from the stage to the substrate being supplied in the second through hole. According to the present invention, at least a portion within the second through hole where the adhesive layer is exposed is covered by a fourth protection member in order to prevent exposure of the adhesive layer. In this way, even when plasma penetrates into the second through hole, the adhesive layer may be protected. It is noted that the second through hole formed in the stage does not necessarily have to penetrate through the bottom surface of the stage; that is, for example, the second hole may alternatively be arranged to penetrate through a side surface of the stage.

According to another embodiment of the present invention, the fourth protection member corresponds to a film that is formed through spraying. In this way, the fourth protection member may be easily formed.

According to another embodiment of the present invention, the first protection member and the electrostatic attraction sheet respectively include a third hole and fourth hole that make up the second through hole, the fourth hole being arranged to be larger in dimension compared to the third hole. In this way, when the fourth protection member is formed through spraying, carbonization of the adhesive layer caused by penetration of sprayed material through the gap formed between an attracting member including the attraction sheet and the first protection member may be prevented, for example.

A substrate processing apparatus according to another embodiment of the present invention includes:

a stage that includes a first side surface and is configured to support a substrate to be processed;

an electrostatic attraction sheet that is arranged on the stage and is configured to attract the substrate with electrostatic force;

a first protection member configured to protect the electrostatic attraction sheet, said first protection member including a second side surface and being arranged on the electrostatic attraction sheet;

a first adhesive layer that is arranged at least between the electrostatic attraction sheet and the first protection member and is configured to bond the electrostatic attraction sheet and the first protection member; and

a second adhesive layer that is arranged to conceal the first adhesive layer.

According to the present invention, a second adhesive layer is arranged to cover and conceal the first adhesive layer. Thus, the first adhesive layer may be protected from plasma, and corrosion of the first adhesive layer may be prevented. In turn, particle generation may be prevented, and the service life of the substrate processing apparatus may be prolonged.

According to another embodiment of the present invention, the second adhesive layer includes silicon. By using an adhesive layer including silicon as the second adhesive layer, for example, in a case where oxygen plasma is used, even when the second adhesive layer is exposed to plasma, the second adhesive layer is merely oxidized into silicon oxide; such a change may not affect the plasma resistivity of the second adhesive layer.

According to another embodiment of the present invention, the second adhesive layer is arranged to reach at least a height at which the electrostatic attraction sheet and the first protection member are bonded to cover the first side surface and the second side surface. By arranging the second adhesive layer at such a height, the first adhesive layer may be segregated from plasma. Also, since the second adhesive layer may simply be applied to the first side surface and the second side surface, the substrate holding apparatus may be easily manufactured.

According to another embodiment of the present invention, a polyimide member that is arranged to surround the second adhesive layer is provided. In this way, the plasma resistivity of the first adhesive layer may be further improved.

According to another embodiment of the present invention, the second adhesive layer is arranged around the first adhesive layer and between the stage and the electrostatic attraction sheet and is configured to bond the stage and the electrostatic attraction sheet. According to the present invention, the second adhesive layer has a function of bonding the stage and the electrostatic attraction sheet as well as a function of protecting the first adhesive layer from plasma to thereby realize efficiency.

According to another embodiment of the present invention, a first through hole that penetrates through the first protection member, the electrostatic attraction sheet, and the stage is formed; a pin configured to transfer the substrate is arranged in the first through hole to be raised and lowered relative to the first through hole; and a third adhesive layer is arranged in the first through hole to cover the first adhesive layer. It is noted that the third adhesive layer may include silicon. Also, the second adhesive layer and the third adhesive layer may be made of the same material.

According to another embodiment of the present invention, a second through hole that penetrates through the first protection member, the electrostatic attraction sheet, and the stage is formed; and a gas supply unit configured to supply heat transfer gas to the substrate at least via the second through hole and a fourth adhesive layer that is arranged in the through hole to cover the first adhesive layer are provided. It is noted that the fourth adhesive layer may include silicon. Also, the second adhesive layer, the third adhesive layer, and the fourth adhesive material may be made of the same material.

A method of manufacturing a substrate processing apparatus according to an embodiment of the present invention corresponds to a method of manufacturing a substrate processing apparatus including a stage that supports a substrate, said stage having a surface and a continuous convex portion surrounding a predetermined region of the surface which convex portion includes a periphery surface and an upper surface that is positioned higher than the surface of the stage; and an electrostatic attraction sheet that attracts the substrate with electrostatic force which electrostatic attraction sheet is arranged within the region surrounded by the convex portion, the method including the steps of:

(A) bonding a first protection member having a side surface to the electrostatic attraction sheet via an adhesive layer in a manner such that a portion of the first protection member is arranged to face opposite the upper surface of the convex portion; and

(B) covering the periphery surface of the convex portion and the side surface of the first protection member to conceal at least the adhesive layer with a second protection member configured to protect the adhesive layer.

According to the present invention, for example, the adhesive layer may be protected from plasma and corrosion of the adhesive layer may be prevented. In this way, particle generation may be controlled and the service life of the substrate processing apparatus may be prolonged. It is particularly noted that by providing the convex portion, the adhesive layer may be protected, and by covering the periphery surface of the convex portion and the side surface of the first protection member with the second protection member, protection of the adhesive layer may be further ensured.

### BRIEF DESCRIPTION OF THE DRAWINGS

FIG. 1 is a cross-sectional view of a plasma etching apparatus according to an embodiment of the present invention;

FIG. 2 is an exploded perspective view of a stage, an electrostatic attraction sheet, and a protection member;

FIG. 3 is an enlarged view of the portion encircled by dashed line A of FIG. 1;

FIG. 4 is an enlarged view of the portion encircled by dashed line B of FIG. 1;

FIG. 5 is an enlarged view of the portion encircled by dashed line C of FIG. 1;

FIG. 6 is a cross-sectional view of a portion of a substrate processing apparatus according to another embodiment;

FIG. 7 is a cross-sectional view of a portion of a substrate processing apparatus according to another embodiment;

FIG. 8 is a cross-sectional view of a portion of a substrate processing apparatus according to another embodiment; and

FIG. 9 is a cross-sectional view of a portion of a substrate processing apparatus according to another embodiment.

### BEST MODE FOR CARRYING OUT THE INVENTION

In the following, embodiments of the present invention are described with reference to the accompanying drawings.

### First Embodiment

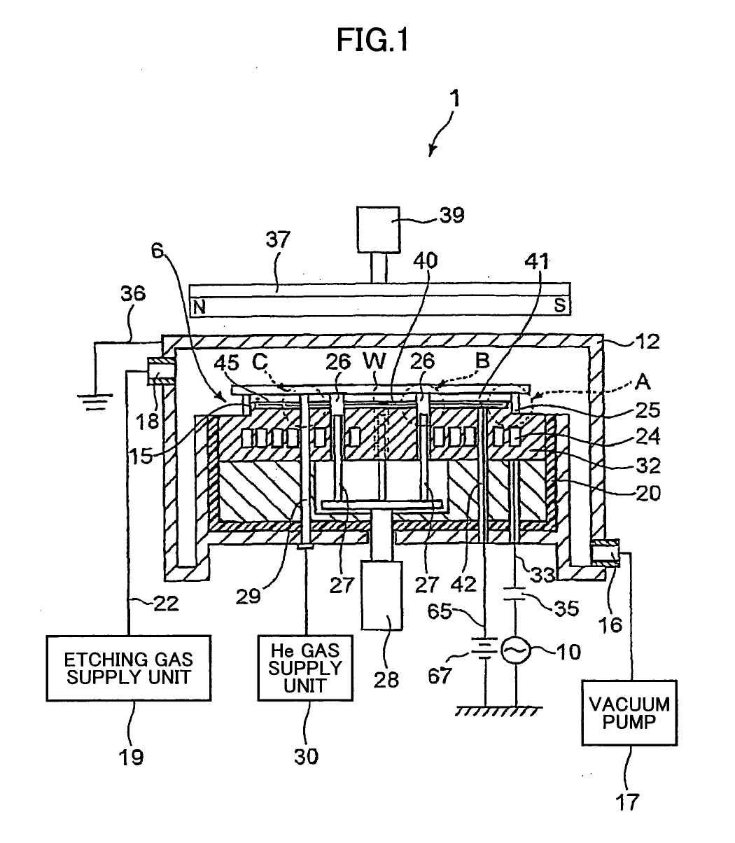

FIG. 1 is a cross-sectional view of a plasma etching apparatus including an electrostatic fastener according to an embodiment of the present invention. The plasma etching apparatus of FIG. 1 includes a vacuum chamber 12, a table 6 for supporting a wafer W within the vacuum chamber 12, a magnet unit 8, for example, that is used for forming a magnetic field in a direction orthogonal to an electric field within the vacuum chamber 12, and an RF power source 10 for generating plasma within the vacuum chamber 12.

It is noted that the vacuum chamber 12 also functions as a container wall.

An evacuation outlet 16 is arranged at the vacuum chamber 12, and a vacuum pump 17 is connected to the evacuation outlet 16. The pressure within the vacuum chamber 12 may be reduced to approximately 1˜100 Pa by the vacuum pump 17. Also, a gas inlet 18 for supplying etching gas is arranged at the vacuum chamber 12. The gas inlet 18 is connected to etching gas supply unit 19 via a supply tube 22. The gas supply unit 19 is arranged to supply etching gas such as oxygen gas, fluorine gas, or chlorine gas. It is noted that the etching gas may also be used as a cleaning gas for cleaning the vacuum chamber 12.

The table 6 is placed within the vacuum chamber 12 via an electrically insulative portion 20 that may be made of heat-resistant material such as ceramic. The table 6 and the vacuum chamber 12 are electrically isolated, and the table 6 includes a stage 32 corresponding to a lower electrode. The stage 32 may be made of aluminum, titanium, molybdenum, or tungsten, for example, containing ceramic. As is described below, the material of the stage 32 is selected so that its thermal expansion rate may be substantially equal to that of a protective member 41. The stage 32 is connected to the RF power source 10 via a lead line 33 and a capacitor 35. It is noted that the vacuum chamber 12 corresponds to an upper electrode and is connected to ground via a lead line 36. The electrodes are arranged to realize a parallel plate electrode structure.

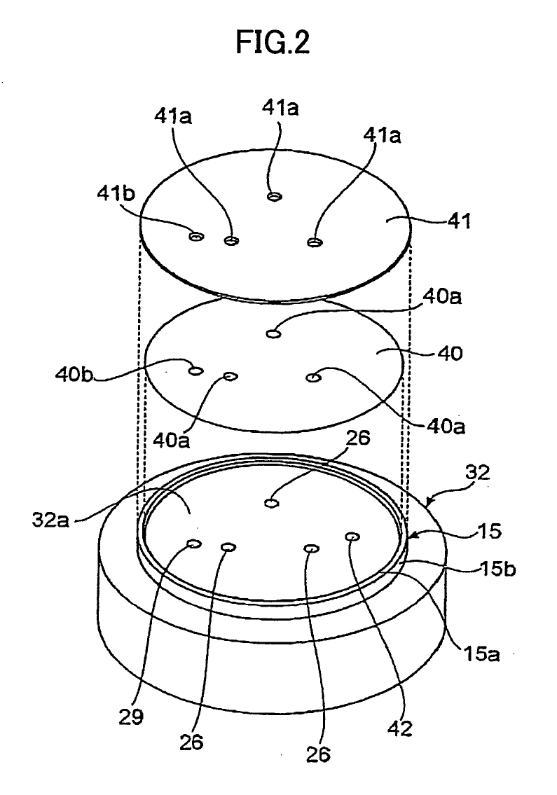

As is shown in FIG. 2, on the upper side of the stage 32, a ring-shaped convex portion 15 is formed around the circumference of the stage 32. In other words, a recessed portion is formed on the upper side of the stage 32. At the inner portion surrounded by the convex portion 15 (recessed portion), an electrostatic attraction sheet 40 for electrostatically attracting the wafer W is arranged to be on and engaged with a surface 32a of the stage 32. A protection member 41 for protecting the electrostatic attraction sheet 40 is arranged on the electrostatic attraction sheet 40. The protection member 41 may be made of sintered ceramic, for example, and the wafer W is placed on this protection member 41. By using sintered ceramic as the protection member 41, the ceramic may be prevented from coming off when the wafer W is attracted and held so that particle generation may be prevented. It is noted that flow channels 24 are formed in the stage 32 for circulating a cooling fluid, for example, to adjust the temperature of the wafer W.

The stage 32 has a number of first through holes 26 (i.e., three in the illustrated example) that penetrate through the stage 32. The electrostatic attraction sheet 40 has holes 40a corresponding to the through holes 26, and the protection member 41 has holes 41a corresponding to the through holes 26. As is shown in FIG. 1, three pins 27 may be inserted through the through holes 26, and the holes 40a and 41a, for example, and these pins 27 may be arranged to be raised and lowered by a drive apparatus 28 that uses an air cylinder or a ball screw, for example. In this way, the wafer W may be transferred back and forth between the etching apparatus 1 and the outside.

Also, a second through hole 29 is arranged to penetrate through the stage 32, the electrostatic attraction sheet 40, and the protection member 41. It is noted that helium gas is supplied to this second through hole from a helium gas supply unit 30. Helium gas corresponds to heat transfer gas, and may be used to fill the space between the electrostatic fastener and the wafer W to realize a pressure of 10 Torr (1.33×10³ Pa), for example. In this way, the temperature difference between the wafer W and the electrostatic fastener may be controlled to be no more than 5° C. It is noted that gas used as the heat transfer gas is not limited to helium, and other gases such as neon (Ne) and argon (Ar) may be used as well. Also, it is noted that helium gas may be used as a gas for preventing electric discharge between the stage 32 and the protection member 41 during plasma processing.

As is shown in FIG. 1, the electrostatic attraction sheet 40 includes a conductive sheet 45. The conductive sheet 45 may be made of copper, for example. The conductive sheet 45 is electrically connected to a lead line 65, and the lead line 65 is connected to a direct current power source 67. Accordingly, a direct current voltage of 2 KV, for example, may be applied from the direct current power source 67 to the conductive sheet 45 via the lead line 65. Also, it is noted that a third through hole 42 is formed at the stage 32 so that the lead line 65 may pass through this through hole 42. The conductive sheet 45 has a thickness of 10 μm, for example. A polyimide sheet 46 discussed below has a thickness of 25 μm, for example.

The magnet unit 8 has the function of forming a horizontal magnetic field that is parallel to the surface of the wafer W between the electrodes within the vacuum chamber 12, for example. The magnet unit 8 may include a support member 37 that is horizontally arranged, a permanent magnet 38 that is supported by the support member 37, and a motor 39 that rotates the support member 37 and the permanent magnet 38.

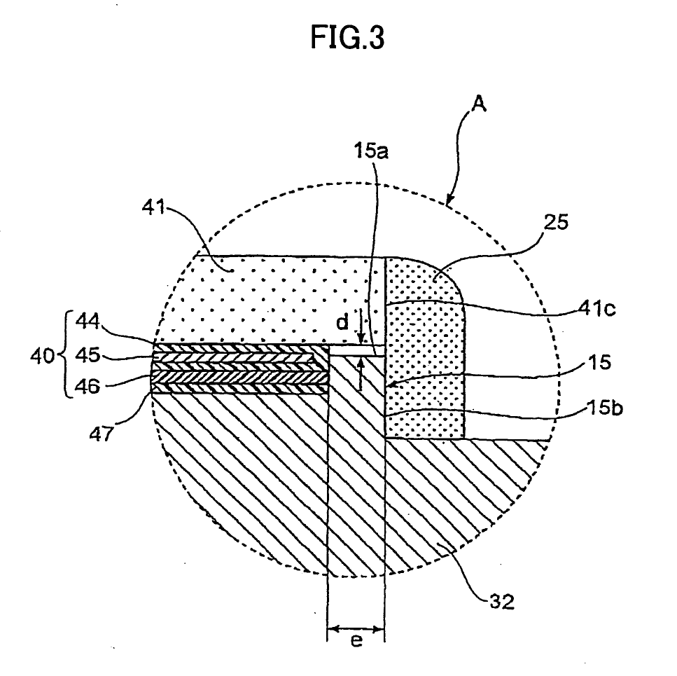

FIG. 3 is an enlarged view of the portion encircled by dashed line A of FIG. 1.

Referring to FIG. 3, the electrostatic attraction sheet 40 may be attached to the surface 32a of the stage 32 by an adhesive layer 47, for example (see FIG. 2). The electrostatic attraction sheet 40 includes the polyimide sheet 46 corresponding to an insulating layer at its lower side, and the conductive sheet 45 that is covered by an adhesive layer 44 is arranged on top of this polyimide sheet 46. Also, the protection member 41 is attached to the electrostatic attraction sheet 40 by the adhesive layer 44. A rim portion of the protection member 41 faces an upper surface 15a of the convex portion 15 via a gap created between the protection member 41 and the upper surface 15a. It is noted that this gap is not actively formed; in other words, a small gap (d) is inevitably formed between the protection member 41 and the electrostatic attraction sheet 40 when the protection member 41 is attached to the convex portion 15 of the stage 32 via the electrostatic attraction sheet 40. For example, when the dimension of the gap (d) (i.e., gap distance) is within a range of 10˜30 μm, the width (e) of the upper surface 15a of the convex portion 15 is arranged to be within a range of 50˜150 μm. Further, a protective ceramic layer 25 that is formed through spraying, for example, is arranged to cover and conceal this gap (d). In other words, the protective ceramic layer 25 is arranged to isolate the adhesive layers 44 and 47, for example, from the processing space within the vacuum chamber 12. Specifically, the protective ceramic layer 25 is formed into a ring shaped structure covering the periphery surface 15b of the convex portion 15 and the side surface 41c of the protection member 41.

In the case where the dimension of the gap (d) is within a range of 10˜30 μm, the width (e) of the upper surface 15a is arranged to be within a range of 50˜150 μm in order to set the aspect ratio of the convex portion 15 to at least 5. It is noted that the aspect ratio is set to at least 5 so that when the dimension of the gap (d) is within a range of 10˜30 μm and the protective ceramic layer 25 is formed through spraying, the sprayed material may be prevented from reaching the adhesive layers 44 and 47. It is noted that when the sprayed material reaches the adhesive layers 44 and 47, carbonization of the adhesive may occur.

According to the present embodiment, the protective ceramic layer 25 is provided so that the adhesive layers 44 and 47 may be protected from plasma, and corrosion of the adhesive layers 44 and 47 may be prevented. In turn, dust or particle generation may be prevented. Also, by providing the protective ceramic layer 25, the service life of the electrostatic fastener or the etching apparatus 1 implementing the electrostatic fastener may be prolonged.

According to the present embodiment, as is described above, the convex portion 15 is arranged on the stage 32, and the electrostatic attraction sheet 40 including the adhesive layer 44 is arranged at the inner side of the convex portion 15. In this way, the adhesive layers 44 and 47 may be protected. By arranging the protective ceramic layer 25 to cover the periphery surface 15b of the convex portion 15 and the side surface 41c of the protection member 41, the adhesive layers 44 and 47 may be protected even more effectively.

According to the present embodiment, the protective ceramic layer 25 is formed through spraying and may thereby be easily formed. For example, when the protective ceramic layer 25 is formed through spraying over portions where the adhesive layers 44 and 47 are exposed, the adhesive layers may be carbonized due to heat from the spraying process. However, according to the present embodiment, the convex portion 15 is provided, and the protective ceramic layer 25 is formed on the periphery surface 15b of the convex portion 15, and thereby, the adhesive layers 44 and 47 may be protected from carbonization, for example.

According to the present embodiment, as is described above, the thermal expansion rate of the stage 32 is arranged to be substantially equal to the thermal expansion rate of the protection member 41. When the thermal expansion rates are not equal, either one of the stage 32 or the protection member 41 may expand at a greater rate than the other when the protective ceramic layer 25 is formed through spraying, and thereby the protective ceramic layer 25 formed through spraying may possibly break as a result. Such a problem may be avoided by arranging the thermal expansion rates to be substantially equivalent.

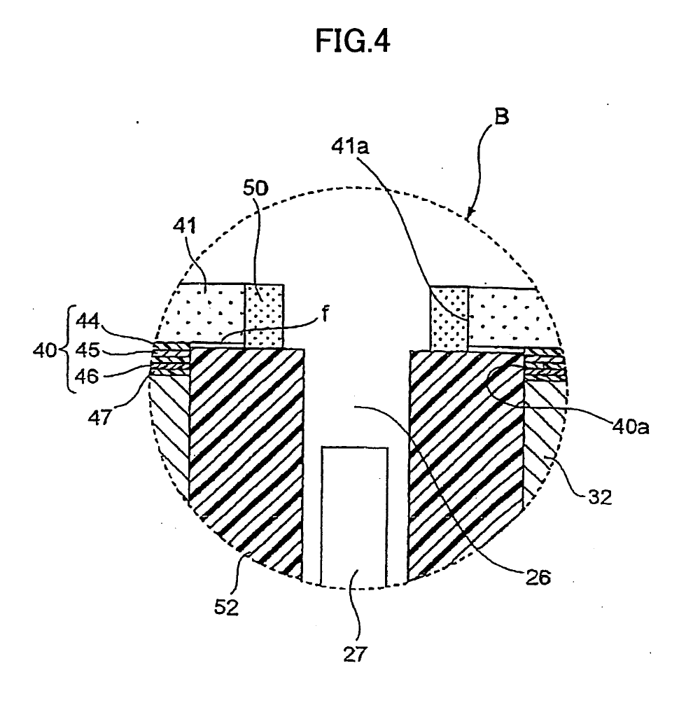

FIG. 4 is an enlarged view of the portion encircled by dashed line B of FIG. 1. Namely, this drawing corresponds to an enlarged view of the first through hole 26 into which the pin 27 is inserted.

Referring to FIG. 4, a sleeve 52 that may be made of an insulative material, for example, is arranged at the first through hole 26. A protective ceramic layer 50 that is formed through spraying is arranged at the hole 41a of the protection member 41. Specifically, the protective ceramic layer 50 is formed into a ring shaped structure around the inner wall surface of the hole 41a to cover the adhesive layers 44 and 47 included in the electrostatic attraction sheet 40. In this way, the adhesive layers 44 and 47 may be protected from plasma that may penetrate through a small gap (f). It is noted that the protective ceramic layer 50 may be made of the same material as that of the protective ceramic layer 25.

Also, it is noted that the diameter of the hole 40a formed in the electrostatic attraction sheet 40 is arranged to be greater than the diameter of the hole 41a formed in the protection member 41. Specifically, as is described above, the aspect ratio of the gap (f) is preferably set to at least 5. In this way, upon forming the protective ceramic layer 50 through spraying, the sprayed material may be prevented from penetrating into the adhesive layers 44 and 47 through the gap (f) and carbonization of the adhesive layers 44 and 47 may be prevented.

FIG. 5 is an enlarged view of the portion encircled by dashed line C of FIG. 1. This drawing corresponds to an enlarged view of the second through hole 29 to which helium gas is supplied.

Referring to FIG. 5, at the second through hole 29, a filter 57 is arranged to be engaged between the protection member 41 and the stage 32. The filter 57 is configured to prevent electric discharge between the protection member 41 and the stage 32 during plasma processing. A protective ceramic layer 55 that is formed through spraying is arranged at a hole 41b of the protection member 41. Specifically, the protective ceramic layer 55 is formed into a ring shaped structure around the inner wall surface of the hole 41b to cover the adhesive layers 44 and 47 included in the electrostatic attraction sheet 40. In this way, the adhesive layers 44 and 47 may be protected from plasma that may penetrate through a small gap (g). It is noted that the protective ceramic layer 55 may be made of the same material as those of the protective ceramic layers 25 and 50.

Also, it is noted that the diameter of the hole 40b formed in the electrostatic attraction sheet 40 is arranged to be greater than the diameter of the hole 41b formed in the protection member 41. Specifically, as is described above, the aspect ratio of the gap (g) is preferably set to at least 5. In this way, upon forming the protective ceramic layer 55 through spraying, the sprayed material may be prevented from penetrating through the gap (g) and into the adhesive layers 44 and 47, and carbonization of the adhesive layers 44 and 47 may be prevented.

In the following, an operation of the plasma etching apparatus 1 that is arranged in the above manner is described.

First, the pins 27 are raised to a predetermined position after which an external transfer apparatus places the wafer W on the pins 27 via a gate valve (not shown) that is implemented in the vacuum chamber 12. When the transfer apparatus exits the chamber 12, the gate valve is closed, and the vacuum pump 17 is activated to reduce the pressure in the chamber 12 to a predetermined pressure such as 1˜100 Pa. Also, the pins 27 are lowered, and as a result, the wafer W is placed on the protection member 41 of the table 6. Further, when the pressure of the chamber 12 is reduced to a predetermined pressure, etching gas is introduced from the etching gas supply unit 19 into the vacuum chamber 12 via the gas inlet 18.

In this state, high frequency electric power of 13.56 MHz, for example, is applied between the upper electrode (vacuum chamber) 12 and the lower electrode (stage) 32 by the RF power source 10, and the permanent magnet 38 is rotated by the motor 39 so that a magnetic field is created between the electrodes. Consequently, cyclonic movement of electrons residing between the electrodes occurs, causing the electrons to collide with the etching gas molecules so that the molecules may be dissociated and ionized and plasma may be generated. The generated plasma acts on the upper surface of the wafer W that is held on the lower electrode 32, and chemical reaction occurs on the surface of the wafer W so that desired chemical etching may be performed.

When the plasma is generated between the upper electrode 12 and the lower electrode 32, electrical conduction occurs between the wafer W and the upper electrode 12 via the generated plasma, and as a result, a negative charge is accumulated at the wafer W. Thereby, the coulomb force increases between the wafer W and the electrostatic attraction sheet at which a positive charge is accumulated, and the attraction force of the electrostatic fastener is enhanced. According to the present arrangement, the wafer W is held to the table 6 only during the period of plasma generation.

When plasma processing is completed, the gas within the vacuum chamber 12 is evacuated, and then, for example, an inactive gas may be introduced into the chamber 12 to create a normal pressure atmosphere. Then, the pins 27 supporting the wafer W are raised, and the wafer W raised in this manner is removed from the chamber 12 to the outside by the transfer apparatus via the gate valve.

After this process, the gate valve is closed once more, and the pressure within the vacuum chamber 12 is reduced to a predetermined pressure. Then, a cleaning gas is supplied from the etching gas supply unit 19, and plasma is generated in the same manner as is described above to realize cleaning of the vacuum chamber 12.

According to the present embodiment, as is described above, since the protective ceramic layers 50 and 55 are arranged in the first through holes 26 and the second through hole 29, respectively, cleaning may be performed without the wafer W being placed inside the chamber 12. It is noted that in the prior art, such protective ceramic layers 50 and 55 are not arranged in the through holes as in the present embodiment. Therefore, in the prior art, for example, a dummy wafer has to be placed on the table 6 upon conducting a cleaning process to cover the through holes so that the adhesive layer that is exposed at the through holes may be protected from plasma. In contrast, according to the present embodiment, such a dummy wafer does not have to be used to perform the cleaning process. Accordingly, the process of introducing the dummy wafer into the vacuum chamber 12 after the etching process may be omitted, and the throughput of the substrate processes may be significantly improved.

For example, according to the present embodiment, a cleaning process may be performed after performing an etching process on a first wafer and before introducing the next wafer into the vacuum chamber 12.

### Second Embodiment

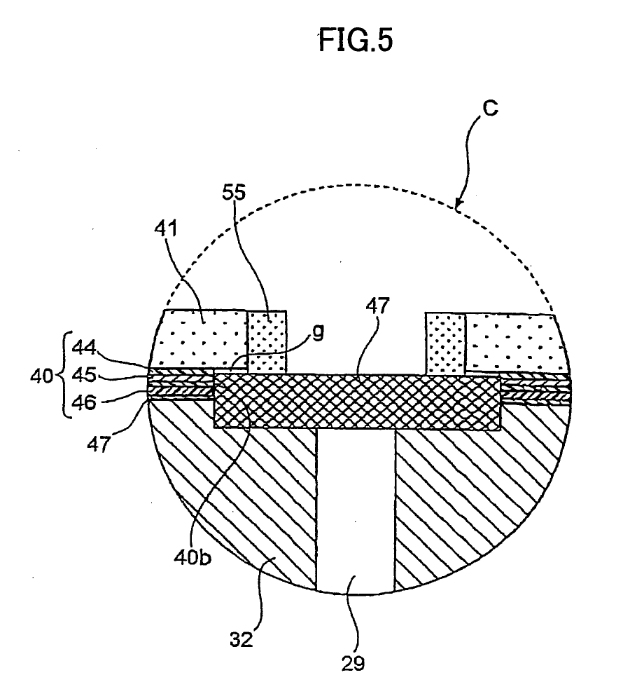

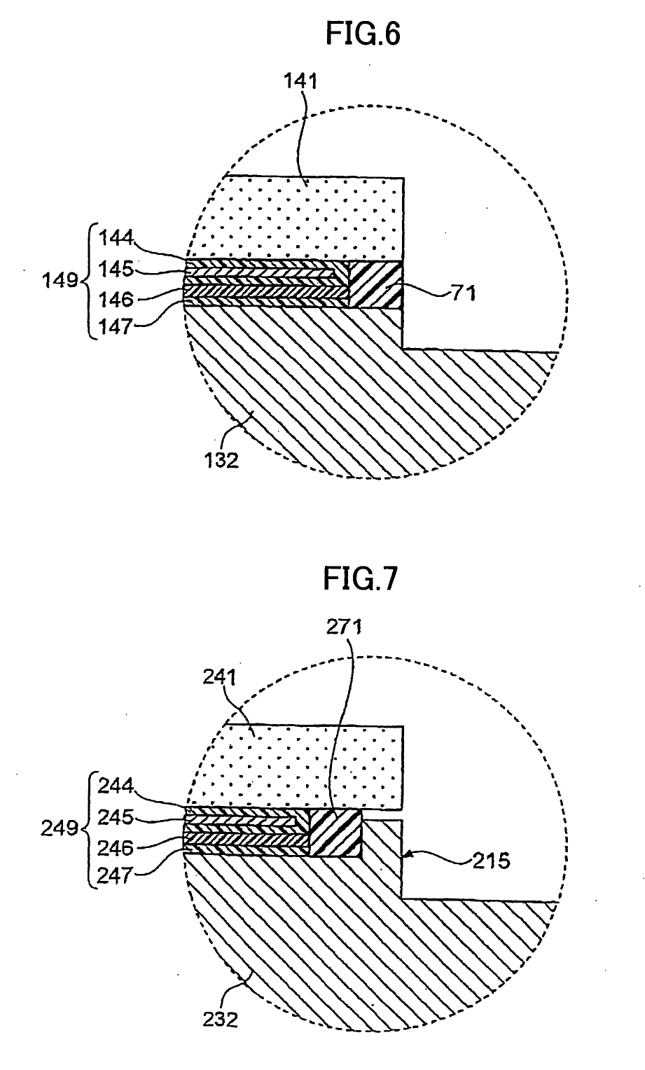

FIGS. 6, 7, 8, and 9 are enlarged cross-sectional views of portions of electrostatic fasteners according to other embodiments of the present invention. It is noted that the portions illustrated in these drawings correspond to the portion shown in FIG. 3 of the first embodiment.

Referring to FIG. 6, the electrostatic fastener according to the present embodiment includes a polyimide sheet 146 placed on a stage 132 via an adhesive layer 147, and a conductive sheet 145, placed on the polyimide sheet 146, covered by an adhesive layer 144. An adhesive layer 149 including such an electrostatic attraction sheet made up of the above layers is surrounded by another adhesive layer 71. In this way, a protective member 141 made of ceramic is attached to the stage 132 via the adhesive layer 149 and the adhesive layer 71. The adhesive layer 71 may include silicon, for example, and is preferably arranged to have relatively high resistance to oxygen plasma. In the case of using plasma derived from another type of gas, a material that has resistance to such type of gas may be included in the adhesive layer 71. By implementing such an arrangement, the adhesive layers 144 and 147 may be protected from plasma. In this way, particle generation may be prevented and the service life of the substrate apparatus may be prolonged.

The electrostatic fastener shown in FIG. 7 has a configuration similar to that shown in FIG. 6 but with the addition of a convex portion 215. An adhesive layer 249 having a similar structure as that of FIG. 6 is arranged at the inner side of the convex portion 215, and another adhesive layer 271 is formed around the adhesive layer 249. The adhesive layer 271 may also include silicon, for example, and is arranged to have relatively high resistance to oxygen plasma. In a case where plasma derived from another type of gas is used, a material that has resistance to such a gas may be included in the adhesive layer 271. In such an arrangement, since the adhesive layer 271 is arranged at the inner side of the convex portion 215, the adhesive layers 144 and 147 may be protected from plasma, and the resistance of the adhesive layer itself may be improved as well. Also, the service life of the substrate apparatus according to the present embodiment may be prolonged even further compared to the apparatus of FIG. 6.

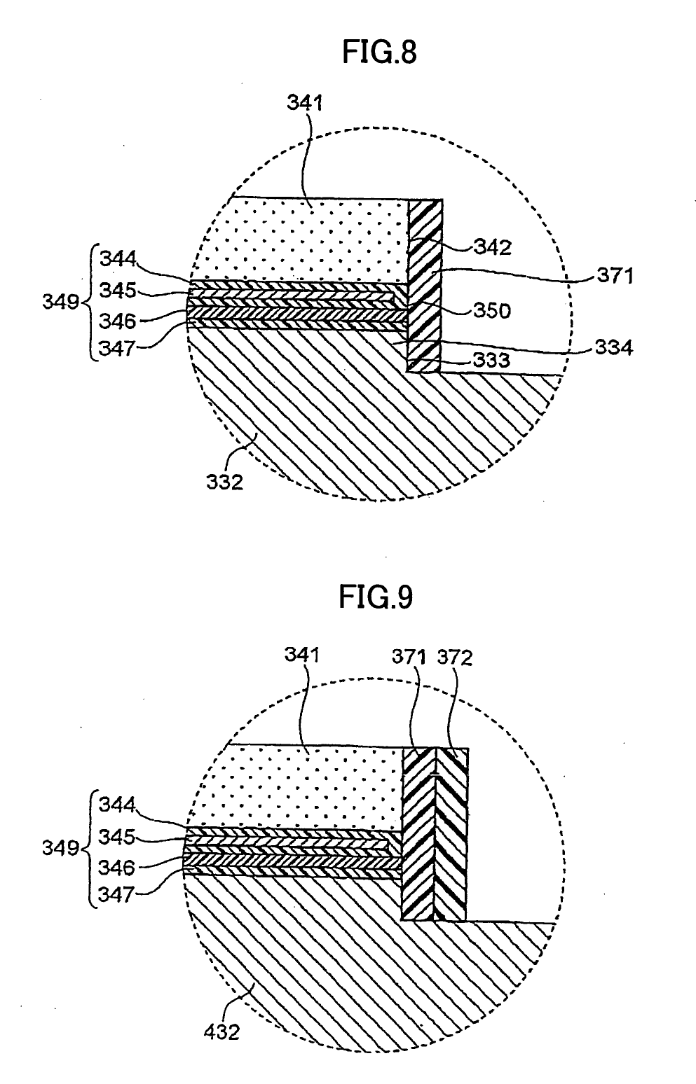

The electrostatic fastener shown in FIG. 8 includes a protection member 341 that is attached to a stepped portion 334 of the stage 332 by an adhesive layer 349. Also, another adhesive layer 371 is formed to cover the periphery of the adhesive layer 349. Specifically, the adhesive layer 371 is attached to the side surface 342 of the protection member 341, the side surface 350 of the adhesive layer 349, and the side surface 333 of the stepped portion 334. The adhesive layer 371 may include silicon, for example, and is arranged to have relatively high resistance to oxygen plasma. In a case where plasma derived from another type of gas is used, a material having resistance to such a gas may be included in the adhesive layer 371. By implementing such an arrangement, the adhesive layer 349 may be protected from plasma. In this way, particle generation may be prevented and the service life of the substrate apparatus may be prolonged.

The electrostatic fastener shown in FIG. 9 includes a polyimide tape 372 that is formed around the adhesive layer 371 of FIG. 8. In this way, the adhesive layer 349 may be protected from plasma. In turn, particle generation may be prevented and the service life of the substrate apparatus may be prolonged even further compared to the apparatus of FIG. 8.

Also, it is noted that in the electrostatic fastener shown in FIGS. 6˜9, spraying as is described in relation to the first embodiment is not performed, and thereby, the thermal expansion rates of the stage and the protection member do not necessarily have to correspond. That is, even when the thermal expansion rates of the stage and the protection member are different, since the adhesive layers 71, 271, and 371 are provided with flexibility, these layers may not be damaged.

Further, it is noted that the present invention is not limited to the specific embodiments described above, and modifications and variations may be made without departing from the scope of the present invention.

For example, an etching apparatus is described as an embodiment of the present invention; however, the present invention may equally be applied to any other type of apparatus that uses plasma such as a CVD apparatus.

Also, adhesive layers may be used in place of the protective ceramic layers 50 and 55 arranged in the first through holes 26 accommodating the pins for transferring the wafer (see FIG. 4) and the second through hole 29 for supplying gas (see FIG. 5). In this case, the adhesive layers used in place of the protective ceramic layers may be made of adhesive material identical to that used for the adhesive layers 71, 271, and 371 of the embodiments illustrated in FIGS. 6˜9.

Also, it is noted that in the embodiments illustrated by FIGS. 6˜9, protective ceramic layers similar to those illustrated in FIGS. 4 and 5 may be arranged in through holes for accommodating pins and for supplying gas (not shown), or adhesive of the same material as the adhesive layers 71, 271, or 371 may be arranged in the through holes.

### INDUSTRIAL APPLICABILITY

As is described above, according to the present invention, in a substrate holding table including an adhesive layer that is used in a substrate processing apparatus, corrosion of the adhesive layer and particle generation may be prevented so that the service life of the substrate processing apparatus may be prolonged.

1. A substrate holding apparatus comprising:
a stage configured to support a substrate to be processed, said stage including a surface, and a continuous convex portion surrounding a predetermined region of the surface which convex portion includes a periphery surface and an upper surface that is positioned higher than the surface of the stage;
an electrostatic attraction sheet configured to attract a substrate with electrostatic force, said electrostatic attraction sheet being arranged on the surface of the stage within the region surrounded by the convex portion;
a first protection member configured to protect the electrostatic attraction sheet, said first protection member being arranged on the electrostatic attraction sheet and including a side surface and a portion that is arranged to face opposite the upper surface of the convex portion;
an adhesive layer that is arranged at least between the electrostatic attraction sheet and the first protection member and is configured to bond the electrostatic attraction sheet and the first protection member; and
a second protection member that covers at least the outer peripheral surface of the convex portion and the side surface of the first protection member to conceal at least the adhesive layer.

2. The substrate holding apparatus as claimed in claim 1, wherein the second protection member corresponds to a film formed through spraying.

3. The substrate holding apparatus as claimed in claim 1, wherein a thermal expansion rate of the stage and a thermal expansion rate of the first protection member are arranged to be substantially the same.

4. The substrate holding apparatus as claimed in claim 1, wherein the first protection member is made of ceramic and the stage is made of at least one of aluminum, titanium, molybdenum, and tungsten that include ceramic.

5. The substrate holding apparatus as claimed in claim 1, wherein a gap is created between the first protection member and the convex portion which gap has a dimension of 10˜30 μm, and the upper surface of the convex portion has a width of 50˜150 am.

6. The substrate holding apparatus as claimed in claim 1, further comprising:
a first through hole that penetrates through the first protection member, the electrostatic attraction sheet, and the stage;
a pin configured to transfer the substrate, said pin being accommodated within the first through hole and being arranged to be raised and lowered relative to the first through hole; and
a third protection member that is arranged in the first through hole to conceal the adhesive layer.

7. The substrate holding apparatus as claimed in claim 6, wherein the third protection member corresponds to a film formed through spraying.

8. The substrate holding apparatus as claimed in claim 7, wherein the first protection member and the electrostatic attraction sheet respectively include a first hole and a second hole that make up the first through hole, the second hole being arranged to be larger in dimension compared to the first hole.

9. The substrate holding apparatus as claimed in claim 1, further comprising:
a second through hole that penetrates through the first protection member, the electrostatic attraction sheet, and the stage;
a gas supply unit configured to supply heat transfer gas to the substrate at least via the second through hole; and
a fourth protection member that is arranged in the second through hole and is arranged to conceal the adhesive layer.

10. The substrate holding apparatus as claimed in claim 9, wherein the fourth protection member corresponds to a film that is formed through spraying.

11. The substrate holding apparatus as claimed in claim 10, wherein the first protection member and the electrostatic attraction sheet respectively include a third hole and fourth hole that make up the second through hole, the fourth hole being arranged to be larger in dimension compared to the third hole.

12. A substrate holding apparatus comprising:
a stage that includes a first side surface and is configured to support a substrate to be processed;
an electrostatic attraction sheet that is arranged on the stage and is configured to attract the substrate with electrostatic force;
a first protection member configured to protect the electrostatic attraction sheet, said first protection member including a second side surface and being arranged on the electrostatic attraction sheet;
a first adhesive layer that is arranged at least between the electrostatic attraction sheet and the first protection member and is configured to bond the electrostatic attraction sheet and the first protection member; and
a second adhesive layer that is arranged to conceal the first adhesive layer.

13. The substrate holding apparatus as claimed in claim 12, wherein the second adhesive layer includes silicon.

14. The substrate holding apparatus as claimed in claim 12, wherein the second adhesive layer is arranged to reach at least a height at which the electrostatic attraction sheet and the first protection member are bonded and cover the first side surface and the second side surface.

15. The substrate holding apparatus as claimed in claim 14, further comprising:
a polyimide member that is arranged to surround the second adhesive layer.

16. The substrate holding apparatus as claimed in claim 12, wherein the second adhesive layer is arranged around the first adhesive layer and between the stage and the electrostatic attraction sheet and is configured to bond the stage and the electrostatic attraction sheet.

17. The substrate holding apparatus as claimed in claim 12, further comprising:
a first through hole that penetrates through the first protection member, the electrostatic attraction sheet, and the stage;
a pin configured to transfer the substrate, said pin being arranged in the first through hole and being arranged to be raised and lowered relative to the first through hole; and
a third adhesive layer that is arranged in the first through hole and is arranged to cover the first adhesive layer.

18. The substrate holding apparatus as claimed in claim 17, wherein the third adhesive layer includes silicon.

19. The substrate holding apparatus as claimed in claim 12, further comprising:
a second through hole that penetrates through the first protection member, the electrostatic attraction sheet, and the stage;
a gas supply unit configured to supply heat transfer gas to the substrate at least via the second through hole; and
a fourth adhesive layer that is arranged in the through hole and is arranged to cover the first adhesive layer.

20. The substrate holding apparatus as claimed in claim 19, wherein the fourth adhesive layer includes silicon.

21. A method of manufacturing a substrate holding apparatus including a stage that supports a substrate, said stage having a surface and a continuous convex portion surrounding a predetermined region of the surface which convex portion includes a periphery surface and an upper surface that is positioned higher than the surface of the stage; and an electrostatic attraction sheet that attracts the substrate with electrostatic force which electrostatic attraction sheet is arranged within the region surrounded by the convex portion, the method comprising the steps of:
(A) bonding a first protection member having a side surface to the electrostatic attraction sheet via an adhesive layer in a manner such that a portion of the first protection member is arranged to face opposite the upper surface of the convex portion; and
(B) covering the periphery surface of the convex portion and the side surface of the first protection member to conceal at least the adhesive layer with a second protection member configured to protect the adhesive layer.

22. The method as claimed in claim 21, wherein the step (B) includes a step of forming the second protection member through spraying.

23. A substrate processing apparatus comprising:
a processing chamber; and
a substrate holding apparatus that is arranged in the processing chamber and is configured to support a substrate to be processed;
wherein the substrate holding apparatus includes
a stage configured to support the substrate to be processed, said stage including a surface, and a continuous convex portion surrounding a predetermined region of the surface which convex portion includes a periphery surface and an upper surface that is positioned higher than the surface of the stage;
an electrostatic attraction sheet configured to attract the substrate with electrostatic force, said electrostatic attraction sheet being arranged on the surface of the stage within the region surrounded by the convex portion;
a first protection member configured to protect the electrostatic attraction sheet, said first protection member being arranged on the electrostatic attraction sheet and including a side surface and a portion that is arranged to face opposite the upper surface of the convex portion;
an adhesive layer that is arranged at least between the electrostatic attraction sheet and the first protection member and is configured to bond the electrostatic attraction sheet and the first protection member; and
a second protection member that covers at least the periphery surface of the convex portion and the side surface of the first protection member to conceal at least the adhesive layer.

24. A substrate processing apparatus comprising:
a processing chamber; and
a substrate holding apparatus that is arranged in the processing chamber and is configured to support a substrate to be processed;
wherein the substrate holding apparatus includes
a stage that includes a first side surface and is configured to support the substrate to be processed;
an electrostatic attraction sheet that is arranged on the stage and is configured to attract the substrate with electrostatic force;
a first protection member configured to protect the electrostatic attraction sheet, said first protection member including a second side surface and being arranged on the electrostatic attraction sheet;
a first adhesive layer configured to bond the electrostatic attraction sheet and the first protection member, said first adhesive layer being arranged at least between the electrostatic attraction sheet and the first protection member; and
a second adhesive layer that is arranged to conceal the first adhesive layer.
